(19) United States
(12) Patent Application Publication
(10) Pub. No.: US 2012/0104304 A1
(43) Pub. Date: May 3, 2012

(54) CONTROL VALVE FOR EJECTING RIVET PIECES OF A RIVET GUN

(76) Inventor: Yu-Ching LIN, Xizhi City (TW)

(21) Appl. No.: 12/912,954

(22) Filed: Oct. 27, 2010

(51) Int. Cl. F16K 27/00

(52) U.S. Cl. 251/366

(57) ABSTRACT

A control valve for ejecting rivet pieces of a rivet gun has an adapter, a bushing, a first valve member and a second valve member. The adapter has cavity and a mounting hole. The bushing is mounted in the mounting hole of the adapter and has a through hole. The first and second valve members are mounted respectively on front and rear ends of the bushing into the through hole. An internal air space is defined between the first and second valve members. Changing the size of the internal air space adjusts an airflow rate inside the control valve so that the moving speed of a rivet piece through the control valve can be controlled.

### BACKGROUND OF THE INVENTION

1. Field of the Invention

The present invention relates to a control valve, and more particularly to a control valve that is mounted in a rivet gun and capable of ejecting rivet pieces such as core pins of a rivet toward a collector on a rear end of a barrel of the rivet gun. The control valve adjusts the ejection speed of the pieces to prevent excessive impact of the rivet pieces to the collector probably damaging the collector and noise incurred thereby.

2. Description of Related Art

Conventional rivet guns are used for mounting rivets on at least two pieces so that the rivets securely hold the pieces together. A rivet has a cap and a core pin. The cap is T-shaped and has an enlarged end and a mounting end. The core pin is mounted longitudinally through, protrudes out of the cap and has two ends and a ball formed on one end and adjacent to the mounting end of the cap.

A conventional rivet gun comprises a barrel, a handle, a trigger, a pin collector and a pneumatic cylinder.

The barrel has a front end, a rear end and a vise assembly that may vise and pull a core pin of a rivet on the front end into the barrel. The handle is mounted perpendicularly on the barrel and has air passageways. The collector is a jar mounted on the rear end of the barrel to collect the ejected core pins. The pneumatic cylinder is mounted movably under the handle and capable of activating the vise assembly through pneumatic and hydraulic means. Furthermore, the pneumatic cylinder may be connected to a high-pressure air source such as an air bottle to implement the ejection of the core pin.

When the rivet gun is used to rivet two pieces such as boards or plates together, a rivet is mounted through the pieces. The enlarged end of the cap of the rivet abuts an inside piece and the front end of the barrel of the rivet gun abuts the enlarged end. The trigger is pulled to activate the vise assembly to pull a core pin on the cap into the barrel. The ball on the core pin longitudinally compresses and radially expands the mounting end of the cap into T-shape so that the expanded mounting end hooks on an outside piece to complete the riveting process. Then, the air output by the high-pressure air source flows through the barrel from the front end to the rear end and sucks the broken core pin vised by the vise assembly backward into the collector

A casing of the pneumatic cylinder is formed integrally and manufactured by insert-molding processes to ensure good airtight/watertight properties thereof. However, disassembling the integrally formed casing is not easy, which raises the difficulty of repairing or replacing components inside the pneumatic cylinder. Therefore, the whole pneumatic cylinder is frequently replaced even though only few inside components are damaged. Maintaining the rivet gun is expensive.

To overcome the shortcomings, the present invention provides a control valve for ejecting rivet pieces of a rivet gun to mitigate or obviate the aforementioned problems.

### SUMMARY OF THE INVENTION

The main objective of the invention is to provide a control valve that is mounted in a rivet gun and capable of ejecting rivet pieces such as core pins of a rivet toward a collector on a rear end of a barrel of the rivet gun. The control valve adjusts the ejection speed of the rivet pieces to prevent excessive impact of the rivet pieces to the collector probably damaging the collector and noise incurred thereby.

A control valve for ejecting rivet pieces of a rivet gun in accordance with the present invention comprises an adapter, a bushing, a first valve member and a second valve member. The adapter has cavity and a mounting hole. The bushing is mounted in the mounting hole of the adapter and has a through hole. The first and second valve members are mounted respectively on front and rear ends of the bushing into the through hole. An internal air space is defined between the first and second valve members. Changing the size of the internal air space adjusts an airflow rate inside the control valve so that the moving speed of a rivet piece through the control valve can be controlled.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional perspective view of a control valve for ejecting rivet pieces of a rivet gun in accordance with the present invention;

FIG. 2 is a cross sectional side view of the control valve and the rivet gun in FIG. 1;

FIG. 3 is a perspective view of the control valve in FIG. 1;

FIG. 4 is another perspective view of the control valve in FIG. 1;

FIG. 5 is an exploded perspective view of the control valve in FIG. 3;

FIG. 6 is another exploded perspective view of the control valve in FIG. 3;

FIG. 7 is a cross sectional side view of the control valve in FIG. 1 omitting the adapter; and

FIG. 8 is an operational cross sectional side view of the control valve in FIG. 7 omitting the adapter.

### DETAILED DESCRIPTION OF THE PREFERRED EMBODIMENT

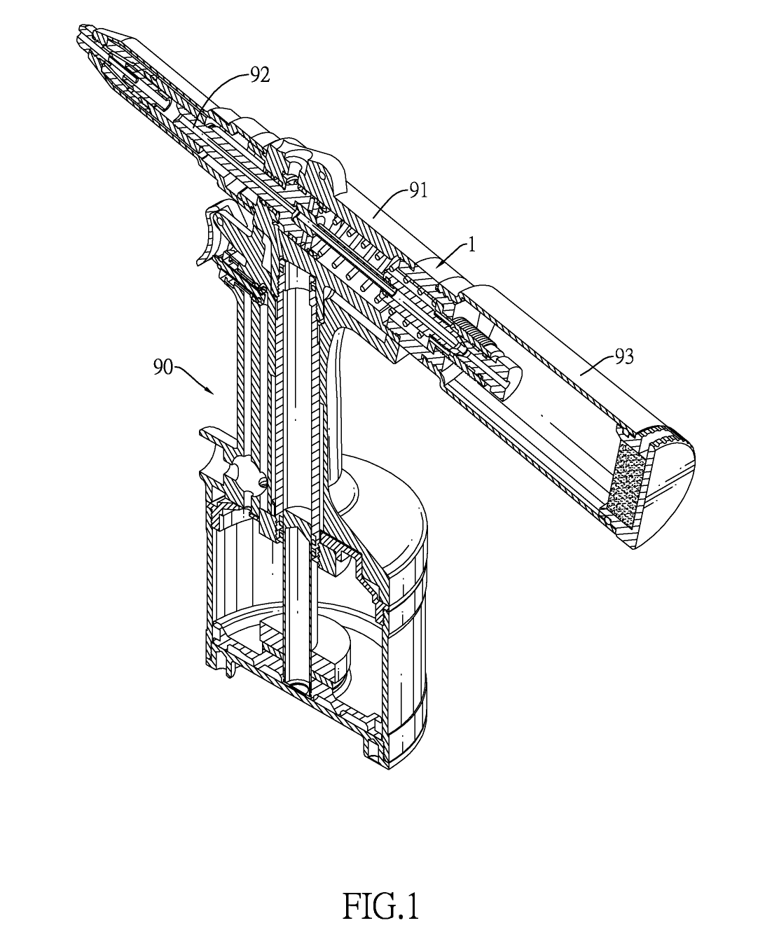

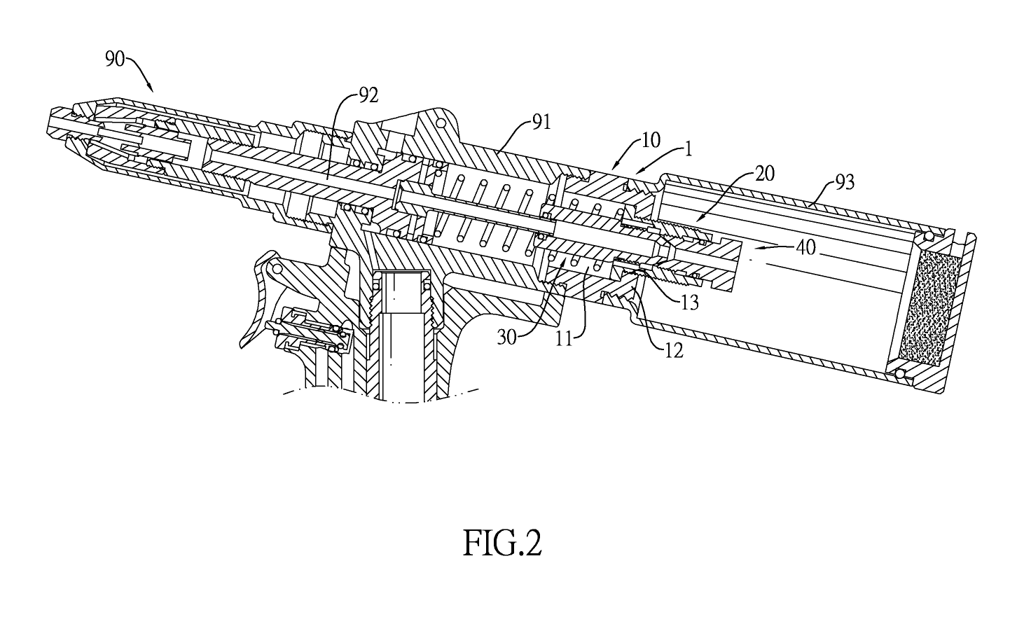

With reference to FIGS. 1 and 2, a control valve 1 for ejecting rivet pieces of a rivet gun in accordance with the present invention may be mounted on a rivet gun 90. The rivet gun 90 has a barrel 91, a handle and a pin collector 93. The barrel 91 has a rear end on which the control valve 1 is mounted and an air passageway 92 defined longitudinally. The handle is mounted under the barrel 91. The pin collector 93 is mounted behind the control valve 1 to collector core pins of rivets.

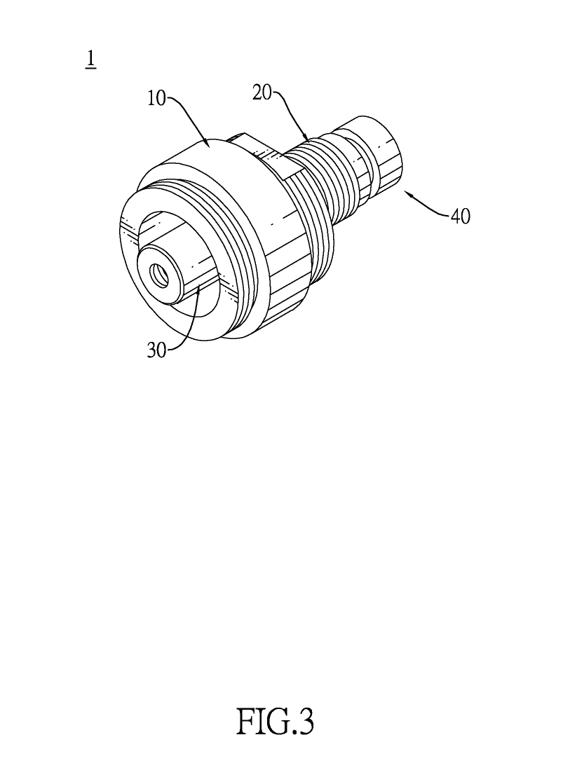

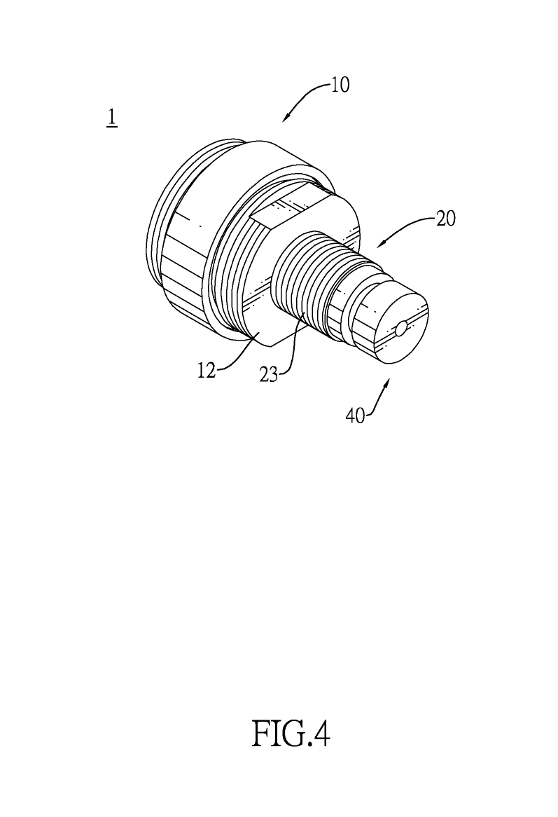

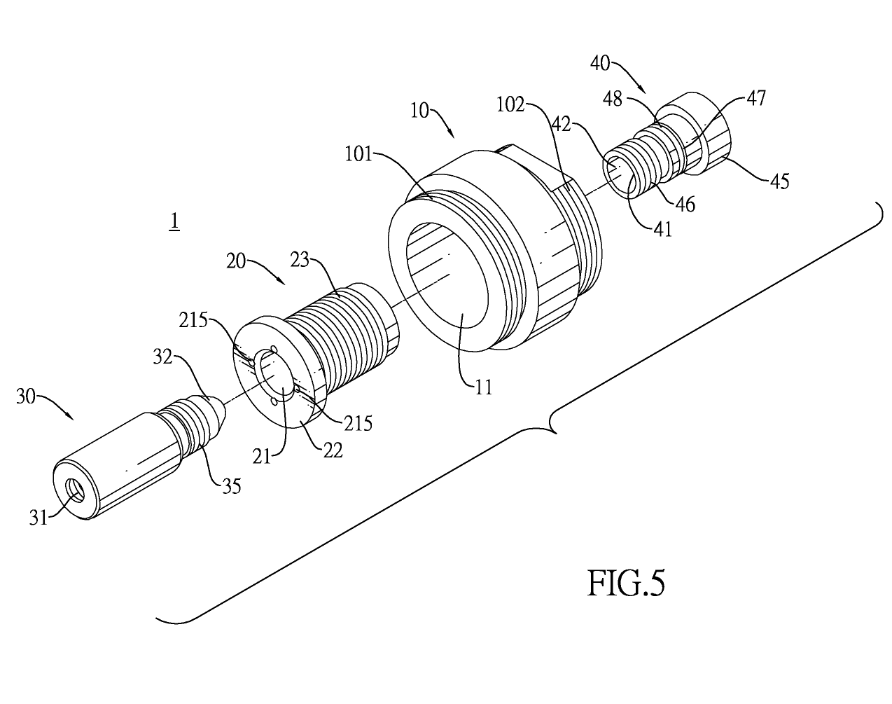

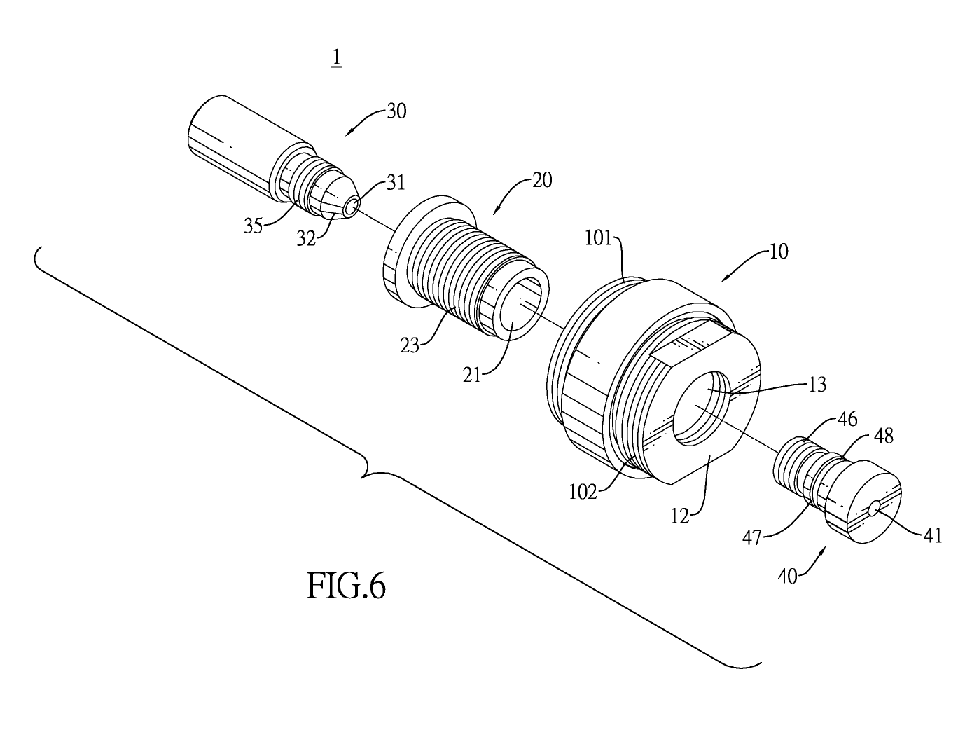

With further reference to FIGS. 3 to 6, the control valve comprises an adapter 10, a bushing 20, a first valve member 30 and a second valve member 40.

The adapter 10 is mounted on the rear end of the barrel 91, has a front end, a rear end 12, a cavity 11 and a mounting hole 13 and may have a front outer thread 101 and a rear outer thread 102. The cavity 12 is defined in the front end of the adapter 10. The mounting hole 13 is defined in the rear end of the adapter 10, communicates with the cavity 11 and may have an inner surface and an internal thread formed on the inner surface. The front outer thread 101 and rear outer thread 102 are formed respectively on the front end and rear end 12 of the adapter 10 and are connected respectively to the rear end of the barrel 91 and the pin collector 93.

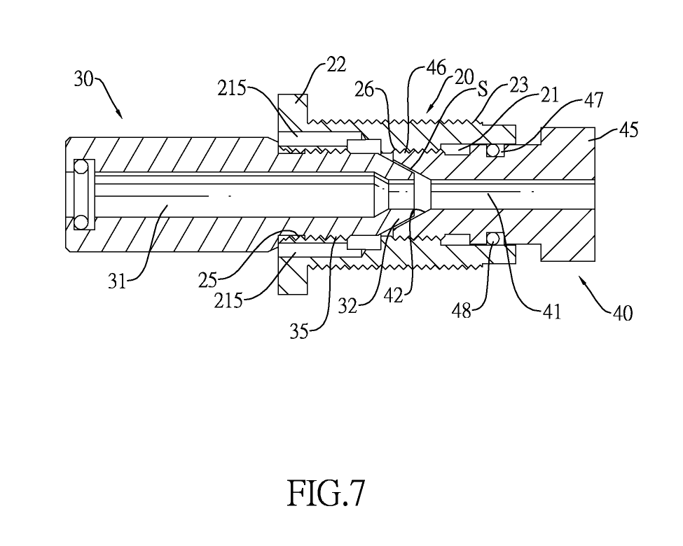

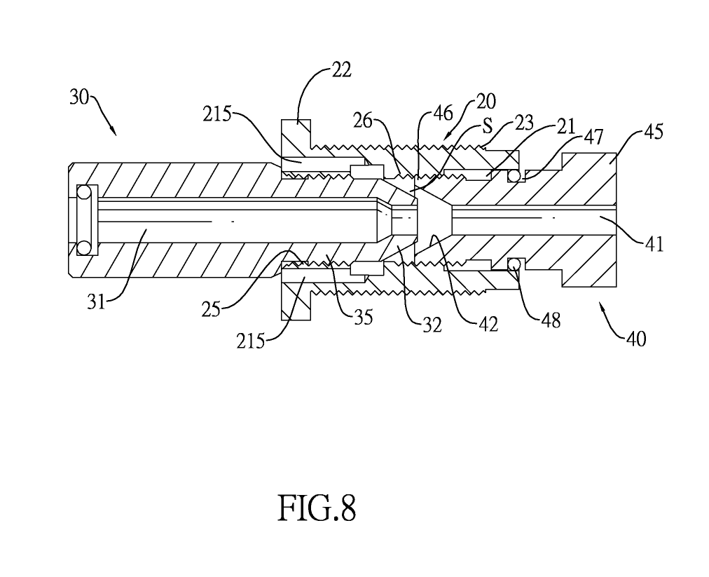

With further reference to FIGS. 7 and 8, the bushing 20 is mounted in the mounting hole 13 of the adapter 10, extends out from the rear end of the adapter 10 and has a front end, a rear end, a through hole 21, a first inner thread 25, a second inner thread 26 and at least one air channel 215 and may further have an outer flange 22 and an external thread 23.

The through hole 21 is defined longitudinally through the bushing 20 and has an inner surface.

The first inner thread 25 is formed on the inner surface of the through hole 21 adjacent to the front end of the bushing 20.

The second inner thread 26 is formed on the inner surface of the through hole 21 behind the first inner thread 25.

The at least one air channel 215 is defined longitudinally in the front end of the bushing 20 and communicates with the through hole 21. The at least one air channel 215 may have a front opening and a rear opening. The front opening is defined at the front end of the bushing 20. The rear opening is defined at the inner surface of the through hole 21.

The outer flange 22 is formed on and protrudes radially from the front end of the bushing 20, is mounted in the cavity 11 of the adapter 10 and presses against an inside wall of the rear end 12 of the adapter 10.

The external thread 23 is formed on the bushing 20 and engages with the internal thread of the mounting hole 13 of the adapter 10.

The first valve member 30 is mounted in the through hole 21 through the front end of the bushing 20 and has a front end, a rear end, a first air hole 31 and a first outer threaded element 35 and may further have a tapered section 32.

The first air hole 31 is defined longitudinally through the first valve member 30 and may allow a core pin of a rivet to pass therethrough.

The first outer threaded element 35 is formed on the first valve member 30 and engages with the first inner thread 25 of the bushing 20 so that rotating the first valve member 30 longitudinally moves the first valve member 30 in the through hole 21 of the bushing 20.

The tapered section 32 is formed on the rear end of the first valve member 30.

The second valve member 40 is mounted in the through hole 21 through the rear end of the bushing 20, has a front end, a rear end, a second air hole 41 and a second outer threaded element 46 and may further have a funneled opening 42, a stopper 45, an annular groove 47 and an O-ring 48.

The second air hole 41 is defined through the second valve member 40 and may allow a core pin of a rivet to pass therethrough.

The second outer threaded element 46 is formed on the second valve member 40 and engages with the second inner thread 26 so that rotating the second valve member 40 longitudinally moves the second valve member 40 in the through hole 21 of the bushing 20 to change a distance between the rear end of the first valve member 30 and the front end of the second valve member 40. An internal air space S is defined between the rear end of the first valve member 30, the front end of the second valve member 40 and the inner surface of the through hole 21, communicates with the first air hole 31 and the second air hole 41 and may communicate with the rear opening of the at least one air channel 215. The internal air space S changes according to the variation of the distance between rear end of the first valve member 30 and the front end of the second valve member 40.

The funneled opening 42 is defined in the front end of the second valve member 40 and corresponds to the tapered section 32 of the first valve member 30.

Preferably, the internal air space S is an annular passageway that is defined between the tapered section 32 of the first valve member 30 and the funneled opening 42 of the second valve member 40.

The stopper 45 is formed on and protrudes radially from the rear end of the second valve member 40 and selectively presses against the rear end of the bushing 20 to prevent the second valve member 45 from excessively extending into the through hole 21.

The annular groove 47 is defined radially in the second valve member 40

The O-ring 48 is mounted in the annular groove 47 and hermetically contacts the inner surface of the through hole 21 of the bushing 20.

The internal air space S between the first valve member 30 and the second valve member 40 changes depending on the distance therebetween. When the internal air space S is reduced, the flow rate of air from the at least one air channel 215 to the internal air space S is lowered. The core pin of a rivet in the first air hole 31 suffers a lower suction force and moves toward the second air hole 41 at a lower speed. When the intern air space S is enlarged, the flow rate of the air from the at least one air channel 215 to the internal air space S is raised. The core pin in the first air hole 31 suffers a higher suction force so moves toward the second air hole 41 at a higher speed. Therefore, the control valve may adjust and lower the speed of the core pin to prevent excessive impact to the pin collector 93.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A control valve for ejecting rivet pieces of a rivet gun, the control valve comprising:
an adapter having a front end, a rear end, a cavity defined in the front end and a mounting hole defined in the rear end and communicating with the cavity;
a bushing mounted in the mounting hole of the adapter, extending out form the rear end of the adapter and having a front end and a rear end and further having
a through hole defined longitudinally through the bushing and having an inner surface;
a first inner thread formed on the inner surface of the through hole adjacent to the front end of the bushing;
a second inner thread formed on the inner surface of the through hole behind the first inner thread;
at least one air channel defined longitudinally in the front end of the bushing and communicating with the through hole;
a first valve member mounted in the through hole through the front end of the bushing, having a front end and a rear end and further having
a first air hole defined longitudinally through the first valve member; and
a first outer threaded element formed on the first valve member and engaging with the first inner thread of the bushing so that rotating the first valve member longitudinally moves the first valve member in the through hole of the bushing; and
a second valve member mounted in the through hole through the rear end of the bushing, having a front end and a rear end and further having
a second air hole defined through the second valve member; and
a second outer threaded element formed on the second valve member and engaging with the second inner thread so that rotating the second valve member longitudinally moves the second valve member in the through hole of the bushing to change a distance between the rear end of the first valve member and the front end of the second valve member; and
an internal air space defined between the rear end of the first valve member, the front end of the second valve member and the inner surface of the through hole and communicating with the first air hole and the second air hole.

2. The control valve as claimed in claim 1, wherein
the first valve member further has a tapered formed on the rear end of the first valve member; and
the second valve member further has a funneled opening defined in the front end of the second valve member and corresponding to the tapered section of the first valve member.

3. The control valve as claimed in claim 2, wherein the at least one air channel has
a front opening defined at the front end of the bushing; and
a rear opening defined at the inner surface of the through hole.

4. The control valve as claimed in claim 3, wherein the bushing further has an outer flange formed on and protruding radially from the front end of the bushing, mounted in the cavity of the adapter and pressing against an inside wall of the rear end of the adapter.

5. The control valve as claimed in claim 4, wherein the second valve member further has a stopper formed on and protruding radially from the rear end of the second valve member and selectively pressing against the rear end of the bushing.

6. The control valve as claimed in claim 5, wherein the second valve member further has
an annular groove defined radially in the second valve member; and
an O-ring mounted in the annular groove and hermetically contacting the inner surface of the through hole of the bushing.

7. The control valve as claimed in claim 6, wherein
the mounting hole of the adapter has an inner surface and an inner thread formed on the inner surface; and
the bushing has an outer thread formed on the bushing and engaging with the internal thread of the mounting hole of the adapter.

8. The control valve as claimed in claim 2, wherein the internal air space is an annular passageway defined between the tapered section of the first valve member and the funneled opening of the second valve member.

9. The control valve as claimed in claim 7, wherein the internal air space is an annular passageway defined between the tapered section of the first valve member and the funneled opening of the second valve member.
